(19) United States
(12) Patent Application Publication
(10) Pub. No.: US 2022/0301055 A1
(43) Pub. Date: Sep. 22, 2022

(54) CONDITIONAL ORDERS

(71) Applicant: Cboe Exchange, Inc., Chicago, IL (US)

(72) Inventor: Mark Beddis, Vancouver (CA)

(21) Appl. No.: 17/700,256

(22) Filed: Mar. 21, 2022

Related U.S. Application Data
(60) Provisional application No. 63/163,555, filed on Mar. 19, 2021.

(51) Int. Cl. G06Q 40/04

(52) U.S. Cl. CPC G06Q 40/04

(57) ABSTRACT

An exchange computer system enhanced with the ability to implement conditional orders is described. Conditional orders can be received from two or more user devices networked with the exchange computer system. The exchange computer system can identify a potential match between the received conditional orders, and can send invitations to trade to each of the user devices from which the potentially matching conditional orders were received. Each invitation can include, for example, a request to generate and send a new firm order corresponding to the respective user's conditional order. If each of the users transmit new firm orders or otherwise confirm willingness to trade based on information provided in the invitations, the exchange computer system can then process and execute a trade based on the new firm orders.

### CROSS REFERENCE TO RELATED APPLICATION

This application claims the benefit of U.S. Provisional Application No. 63/163,555, filed Mar. 19, 2021, which is incorporated herein by reference in its entirety.

### TECHNICAL FIELD

This application relates to technology for trading financial instruments in electronic exchanges and implementing conditional orders in the electronic exchanges.

### BACKGROUND

High volumes of financial instruments, such as derivatives, stocks, and bonds, are continuously traded in real time at electronic exchanges through algorithmic processing of orders and associated market information. Generally, a trade may be executed when the price associated with a bid to purchase a financial instrument matches the price associated with an offer to sell the same instrument. Market participants typically price their bids and offers based on market conditions. However, when market conditions change rapidly, a market participant's fixed order may no longer be desirable for the market participant. In particular, in an environment in which millions of transactions are executed each second and unforeseen events occur frequently, market participants would benefit from greater control and flexibility over their orders and reduction of the losses that may occur as a result of changing market conditions.

### SUMMARY

This disclosure relates to conditional orders in an exchange computer system. Unlike firm orders (e.g., market orders), a conditional order does not have to be filled instantly. Instead, a conditional order allows a market participant to set a preferred quantity or price at which to bid or offer for a financial instrument, with the aim of completing the order either all at once, or in a series of trades with other conditional order participants. As such, an improved exchange computer system enabling conditional orders provides market participants with additional flexibility, allows trades to occur that otherwise would not have occurred, and reduces the amount of network traffic necessary to implement complicated strategies, thereby freeing up resources and bandwidth for every machine involved, both local and remote to the exchange.

For example, a conditional order can be entered well in advance of the related trade(s), such that the market participant's preferences for completing that order are input to the computer exchange system, which then can monitors market activity to identify potentially matching orders on behalf of that market participant, and then invite participants to trade when the potential matches are identified.

For instance, a first market participant can place a first conditional order for selling a particular quantity of a financial instrument at a certain price and optionally place a firm order for selling a different quantity of the financial instrument at the same or different price. A second market participant can place a second conditional order for buying a certain quantity of the financial instrument at a certain price. The exchange computer system can determine that the terms (e.g., price, quantity) of the first conditional order and the terms of the second conditional order match. The exchange computer system can then generate a pair of invitations for the market participants to submit new firm orders matching the terms of the identified conditional orders. Upon receiving the new firm orders from both market participants in place of the conditional orders (or in some implementations generating the new firm orders based on other information received from the participants), the exchange computer system can execute a trade between the two market participants based on the new firm orders. If the first market participant had made both the first conditional order and a different firm order before a potential match was identified, the different firm order could be canceled and effectively replaced by a new firm order.

In addition, a scorecard can be used to monitor the performance of market participants with respect to the conditional order system, and to limit the likelihood of market participants not honoring conditional orders. For instance, if a market participant does not have sufficient volume to trade when an invitation is received (after a potential match is identified), and consequently cannot complete a trade, the market participant may receive a negative adjustment to their score. If a market participant has sufficient volume to trade when the invitation is received and subsequently completes a trade, the market participant may receive a positive adjustment to their score. A market participant's scorecard can aggregate all or a portion of the market participant's previously received scores. Accordingly, each market participant's scorecard is indicative of the market participant's performance in completing conditional orders. A market participant that has an aggregate score that falls below a threshold level can, for example, be blocked from further participation in the exchange's conditional order system. Due to consequences of poor performance, market participants will be more likely to honor their conditional offers.

According to some aspects, a method for conditional trading implemented via an exchange computer system includes receiving, from a first user device connected to the exchange computer system, data indicative of a first conditional order for a financial instrument, and receiving, from a second user device connected to the exchange computer system, data indicative of a second conditional order for the financial instrument. The method includes determining that the first conditional order and the second conditional order potentially match, and sending an invitation to the first user device to submit a first firm order for the financial instrument and an invitation to the second user device to submit a second firm order for the financial instrument responsive to determining that the first conditional order and the second conditional order potentially match. The method includes receiving the first firm order for the financial instrument from the first user device and the second firm order for the financial instrument from the second user device, and executing a trade based on the first firm order and the second firm order, and sending a first report to the first user device and a second report to the second user device. The first report and second report each include data indicative of a quantity of the financial instrument traded.

In some implementations, the exchange computer system is a distributed computer system that includes an order entry port, an order routing system, an order matching system, and a conditional order engine.

In some implementations, the order entry port is configured to receive the first conditional order. The order routing system is configured to route the first conditional order according to a destination associated with the first conditional order. The conditional order engine is configured to determine that the first conditional order and the second conditional order potentially match based on one or more matching rules. The order matching system is configured to match the first firm order and the second firm order.

In some implementations, the first conditional order includes a first quantity of the financial instrument. The second conditional order includes a second quantity of the financial instrument, and the quantity of the financial instrument traded is equal to the second quantity.

In some implementations, the method further comprises receiving data indicative of a third conditional order for the financial instrument. The first quantity is equal to or greater than a sum of the second quantity and a third quantity of the financial instrument associated with the third conditional order.

In some implementations, the invitation does not indicate the second quantity.

In some implementations, the invitation indicates the second quantity.

In some implementations, the method further includes determining that the first quantity is available to trade responsive to receiving the first firm order for the financial instrument.

In some implementations, the trade based on the first firm order and the second firm order is executed responsive to determining that the first quantity is available to trade.

In some implementations, the method further includes determining that the second quantity is available to trade responsive to receiving the first firm order for the financial instrument.

In some implementations, the method further includes generating, based on the execution of the trade, a score indicative of a trading performance of a user of the first user device.

According to some aspects, a method for conditional trading is implemented via an exchange computer system. The method includes receiving, from a first user device connected to the exchange computer system, data indicative of a first conditional order for a financial instrument. The first conditional order includes a first quantity of the financial instrument. The method includes receiving, from a second user device connected to the exchange computer system, data indicative of a second conditional order for the financial instrument. The second conditional order includes a second quantity of the financial instrument. The method includes determining that the first conditional order and the second conditional order potentially match, and sending an invitation to the first user device to submit a first firm order for the financial instrument and an invitation to the second user device to submit a second firm order for the financial instrument. The method includes receiving the first firm order for the financial instrument from the first user device and the second firm order for the financial instrument from the second user device, determining that the first quantity is not available to trade, canceling the first firm order and the second firm order, and sending a report to the first user device including data indicative of the cancelation of the firm order and a report to the second user device including data indicative of the cancelation of the second firm order.

In some implementations, the method further includes generating, based on the determination that the first quantity is not available to trade, a score indicative of a trading performance of a user of the first user device.

In some implementations, the method further includes determining that the score indicative of the trading performance of the user of the first user device is less than a threshold value, and blocking the user of the first user device from participating in conditional trading.

According to some aspects, a method for conditional trading is implemented via an exchange computer system. The method includes receiving, from a first user device connected to the exchange computer system, data indicative of a first conditional order for a financial instrument. The first conditional order includes a first quantity of the financial instrument. The method includes receiving, from a second user device connected to the exchange computer system, data indicative of a second conditional order for the financial instrument. The second conditional order includes a second quantity of the financial instrument. The method includes determining that the first conditional order and the second conditional order potentially match, and sending an invitation to the first user device to submit a firm order for the financial instrument responsive to determining that the first conditional order and the second conditional order potentially match. The method includes determining that the first user device did not respond to the invitation, and canceling the first conditional order.

In some implementations, the method further includes generating, based on the determination that the first user device did not respond to the invitation, a score indicative of a trading performance of a user of the first user device.

In some implementations, the method further includes receiving data indicative of a third conditional order for the financial instrument from a third user device connected to the exchange computer system, determining that the second conditional order and the third conditional order potentially match, sending an invitation to the second user device to submit a second firm order for the financial instrument responsive to determining that the second conditional order and the third conditional order potentially match, receiving a second firm order for the financial instrument from the second user device, executing a trade based on the second firm order and the third conditional order, and sending a report to the second user device. The report includes data indicative of a quantity of the financial instrument traded.

In some implementations, the exchange computer system is a distributed computer system including an order entry port, an order routing system, an order matching system, a conditional order engine, and a purge port.

In some implementations, the order entry port is configured to receive the first conditional order. The order routing system is configured to route the first conditional order according to a destination associated with the first conditional order. The conditional order engine is configured to determine that the first conditional order and the second conditional order potentially match based on one or more matching rules. The purge port is configured to cancel the first conditional order.

The implementations described in this disclosure provide several systematic and procedural advantages that improve an exchange computer system. For example, the described implementations allow a exchange computer system to (1) process a greater volume of transactions in shorter periods of time; (2) improve exchange performance and customer satisfaction by allowing participants to trade larger volumes of financial instruments in a conditional or paired manner than volumes they would otherwise trade using firm orders; (3) increase the bid-ask spread while minimizing risk exposure to market participants; (4) reduce network congestion when user's opt not to use invitations for generating firm orders; and (5) improve computerized accountability of market participants.

For example, through the user of paired or conditional orders (which a market participant would otherwise be unwilling to do), the exchange computer system can process a larger volume of trades at a faster pace and increase profitability. Because pairs are simultaneously executed, latency is also improved. Risk is minimized through the use of a conditional order and through a order generation mechanism through which conditional orders can be leveraged to generate firm orders (by virtue of invitations and/or hardware and software in the exchange computer system as described above). Market participants are held accountable by virtue of the exchange computer system scorecard, and can be punished for poor performance by being prohibited from trading if a participant's performance score falls below a threshold level. In this way, the exchange computer system can also ensure that the quality and performance of both the trades and the traders are improved.

Other implementations of this aspect include corresponding systems, devices, processes, apparatus, computer-readable media, and computer programs recorded on computer storage devices, each configured to perform the operations of the methods.

The details of one or more embodiments of the subject matter described in this specification are set forth in the accompanying drawings and the description below. Other potential aspects, features, and advantages will be apparent from the description, the drawings, and the claims.

### BRIEF DESCRIPTION OF THE DRAWINGS

FIG. 1 is an example diagram of an exchange computer system and associated networks, devices, and users.

FIG. 2 is a flowchart of an example method for implementing conditional orders in an electronic exchange system.

### DETAILED DESCRIPTION

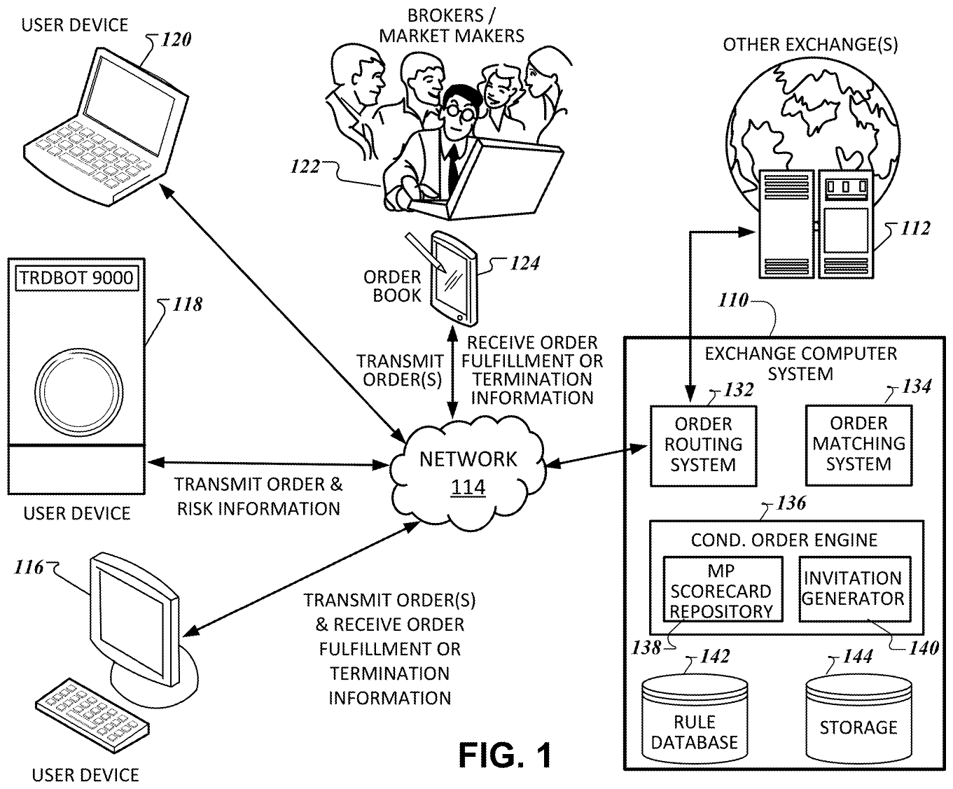

FIG. 1 is an example diagram of an exchange computer system and the associated networks, devices, and users that make up an exemplary trading environment in which the exchange computer system operates. The diagram includes an exchange computer system 110, other exchanges 112, a network 114, user devices 116, 118, 120, market makers/brokers 122, and an electronic order book 124. Generally, the term “user” can refer to any entity that interacts with the exchange computer system and/or associated networks and devices. Users can include, for example, market makers, market participants, brokers, institutional traders, individual traders, and automated trading systems.

In some cases, a user can refer to a member, as defined under exchange rules, or a clearing member, who is a member of a Qualified Clearing Agency authorized to clear transactions on behalf of another member, as defined under exchange rules. If a clearing member is the user, the clearing member can be required to request authorization from the exchange control system 110 to receive data indicative of a current or previous risk profile setting of the member on behalf of whom the clearing member is acting.

The exchange computer system 110 can be implemented in a fully electronic manner, or in a hybrid manner that combines electronic trading with aspects of traditional open-outcry systems. The exchange computer system 110 can receive orders for trading financial instruments locally on the floor and from remote electronic devices. The financial instruments can include securities such as stocks, options, futures, or other derivatives associated with an underlying asset.

The orders received and processed by the exchange computer system 110 can include conditional orders and firm orders. Conditional orders are orders to buy or sell a financial instrument when conditions specified by the user are satisfied. Conditional orders can include limit orders and stop orders. A limit order is an order to automatically buy or sell a financial instrument at a maximum bid price to be paid or at a minimum offer price to be received, as specified by the user. A stop order is an order to buy or sell when the financial instrument's market price has reached or surpassed the user's requested price. Limit orders and stop orders can be placed above and below the market price. In contrast to conditional orders, a firm order is an order placed on behalf of a firm (rather than a firm's client) and is not dependent upon a later confirmation by the client or conditions set by the client.

Network 114 connects the various components within the trading environment, and is configured to facilitate communications between those components. For example, network 114 can enable the exchange of electronic communications that include order and order fulfillment information between connected devices, such as an electronic order book 124 and the exchange computer system 110.

Network 114 can include one or more networks or subnetworks, each of which can include a wired or wireless data pathway. Network 114 can, for example, include one or more of the Internet, Wide Area Networks (WANs), Local Area Networks (LANs), or other packet-switched or circuit-switched data networks that are capable of carrying electronic communications (e.g., data or voice communications).

In some implementations, the network 114 can include a communications network inclusive of hardware and software implemented on various systems, devices, and components connected to network 114. In some implementations, trader information, such as a trader's speech and actions, can be recorded by a user device (e.g., a computer or portable device such as a cellular phone) at the location of the trader using sensors, cameras and microphones, and can be continuously transmitted across the network 114 to other devices connected to the network 114.

To protect communications between the various systems, devices, and components connected to network 114, network 114 can implement security protocols and measures such that data identifying order or bid information, or parties placing orders or quotes, can be securely transmitted. Network 114 can, for example, include virtual private networks (VPNs) or other networks that enable secure connections to be established with exchange computer system 110.

User devices 116, 118, and 120 can include portable or stationary electronic devices, such as smartphones, laptops, desktops, and servers that include user interfaces to display information and receive user input, and that are configured to communicate over a computer network. User devices 116, 118, and 120 can communicate with the exchange computer system 110 over network 114 using a proprietary protocol, or a message-based protocol such as financial information exchange (FIX), implemented over TCP/IP. The user devices 116, 118, and 120 may include or be coupled to one or more user interfaces such as a keyboard, mouse, or display device through which user input, such as user selections, can be received. For example, a display device in a user device 116, 118, or 120 can be configured to display a web portal or graphical user interface through which a user can provide input related to a conditional order.

User devices 116, 118, and 120 can transmit user input such as order information, including any conditional orders, to the exchange computer system 110, and can also receive data from the exchange computer system 110 indicating that an order has been filled or canceled. The data can be conveyed in various suitable ways including, for example, in the form of a report providing details of a trade or cancellation. The details in the report can include one or more of the parties or firms involved, the financial instrument being traded, the price and quantity of the trade, the time at which the trade was completed or canceled, and the venue of the exchange at which the trade was executed or canceled. In some implementations, one or more details of the report can be sanitized or anonymized such that the one or more details (e.g., parties involved in the trade, or volume traded) of the report are omitted from the report.

Users, such as brokers/market makers or participants 122, can also place orders and receive information about order fulfillment or termination through electronic order book 124, which can include a record of outstanding public customer limit orders that can be matched against future incoming orders.

The exchange computer system 110 includes an order entry port (not shown), order routing system (ORS) 132, an order matching system (OMS) 134, a conditional order processor 136, a database of trading rules and algorithms 142, and storage 144. The conditional order engine 136 includes a market participant (MP) scorecard repository 138 and an invitation generator 140. The exchange computer system 110 can be integrated at a single location or a single device, e.g., in the form of a server, or can be distributed over a wired or wireless computer system.

The order routing system (ORS) 132 can determine whether a received order or quote is to be executed at the exchange computer system 110, or should instead be redirected to another exchange 112. The ORS 132 can include or be coupled to processing systems that enable the management of high data volumes and one or more order entry ports that are configured to receive order or quote information (e.g., a conditional order) for the purchase or sale of financial instruments from one or more user devices 116, 118, 120, and 124. In some implementations, the ORS 132 can also be connected to or include a touch-screen order routing and execution system accessible by brokers on the exchange floor, such as a public automated routing (PAR) system.

Upon receiving an order or quote, the ORS 132 can determine if the destination specified in the received order or quote is the exchange computer system 110. If the exchange computer system 110 is not the destination, the ORS 132 forwards the order or quote to another exchange 112, which can be either the destination exchange, or an exchange en route to the destination exchange.

If the ORS 132 determines that the exchange computer system 110 is the destination of the received order or quote, the ORS 132 can forward the received order or quote to the order matching system 134. The ORS 132 can include or be coupled to an order entry port that receives the order and forwards the received order to the order matching system 134. In some implementations when processing conditional orders, the ORS 132 is configured to route a conditional order according to a destination associated with the first conditional order.

The order matching system (OMS) 134 includes processing systems that analyze and manipulate orders according to matching rules stored in the database 142. The OMS 134 can also include an electronic book (EBOOK) of orders and quotes with which incoming orders to buy or sell are matched, according to the matching rules. The EBOOK can also be implemented in a separate database such as storage 144, which can include multiple mass storage memory devices for the storage of order and quote information. When the OMS 134 determines that a match exists for an order (for example, when a bid matches an offer for sale), the order matching system 134 can mark the matched order or quote with a broker-specific identifier so that the broker sending the order or quote information can be identified.

Upon completion of a trade (through the floor in open outcry as entered into the PAR system, or through automatic execution through the OMS 134), the fill information is passed through OMS 134 and ORS 132 to one or more user devices 116, 118, 120, and 124, and to a continuous trade match (CTM) system. The CTM system matches the buy side and sell side of a trade, and forwards the matched trade to a third party organization that verifies the proper clearance of the trade, such as the Options Clearing Corporation (OCC) where the securities can be options, or the Depository Trust Company (DTC) where the securities can be equities. The OMS 134 also formats the quote and sale update information and sends that information through an internal distribution system that refreshes display screens on the floor, in addition to submitting the information to a quote and trade dissemination service such as, in the case of options, the Options Price Reporting Authority (OPRA). In the case of equities, the information would be submitted to the Securities Information Processor (SIP).

Storage 144 and database 142 store and handle data in a manner that satisfies the privacy and security requirements of the exchange computer system 110 and its users, and can store one or more of telemetric data, user profiles, user history, and rules and algorithms for matching quotes, bids, and orders.

Rules database 142 can store data that specifies the rules by which the exchange computer system 110 can operate, as well as specific rules for processing conditional orders. For example, rules database 142 can rules identifying the type of conditions that can be applied to an order and how a market participant can be scored upon the completion or failure of a conditional order.

The exchange computer system 110 includes a conditional order engine 136, which can be implemented using a combination of software and hardware configured to execute one or more algorithms for processing conditional orders, as described in further detail below. In some implementations, one or more parts of the conditional order engine 136 can be integrated with other parts of the exchange computer system 110. For example, the market participant (MP) scorecard repository 138 can be implemented within storage 144, which could be integrated with or coupled to the conditional order engine 136. In some implementations, a processor of the conditional order engine 136 may be integrated with or coupled to one or more processors of the exchange computer system 110 such as a processor of the order routing system 132 and/or order matching system 134. The conditional order engine 136 can be coupled to one or more user interfaces such as a keyboard, mouse, or display device.

The MP scorecard repository 138 is a database in which the scorecards for the various users of the exchange computer system 110 are stored. A scorecard can be generated for each user and is representative of the aggregate score for each user. A user can be scored based on a trading performance of the user. If a user has a strong record of filling orders and following market participant rules, obligations, and protocols, the user receives positive scores. In contrast, if a user has a weak record of filling orders and following market participant rules, obligations, and protocols, the user receives negative scores.

As an example, if a user has placed a conditional order, but at the time a match for the conditional order is found, can no longer fill the order, e.g., due to insufficient volume or available funds, the user will receive a negative score. In contrast, if the user places a conditional order and is able to convert the conditional order to a firm order and execute the order, the user will receive a positive score.

Different scores can be assigned to users based on the type of action, transaction, or violation. For instance, a user who completes a high volume or value trade may receive a higher positive score than a user who completes a lower volume or value trade. A user who completes a firm order may receive a first score (which can be implemented in the form of points) as the user's score. A user who completes a trade based originally from a conditional order may receive a second score (e.g., second number of positive points) that is different from the first score (e.g., first number of positive points).

A user who violates an ethical obligation, consistently breaches a code of conduct, or whose score on the scorecard falls below a minimum scorecard threshold level, may be blocked from participating in subsequent transactions with the exchange computer system 110. Scores from other venues can also be factored into the score of a user at the exchange computer system 110. Thus, if a user has a poor score at another venue, the poor score can be factored into the score of the user and result is a poor score of the user at the exchange computer system 110.

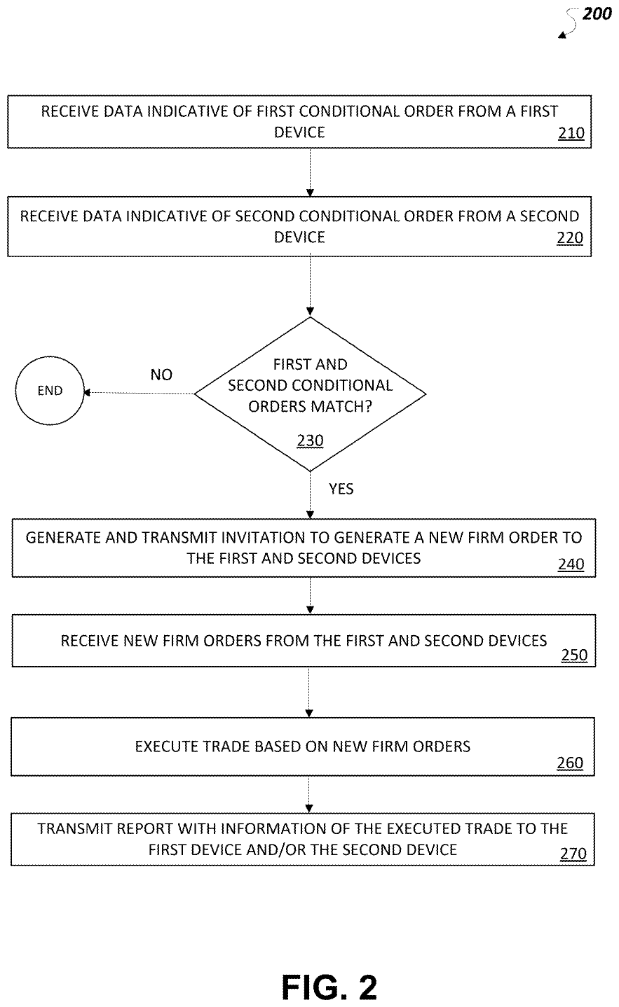

Before a transaction is conducted or in response to receiving any order from a user, the exchange computer system 110 can check the score of the user and determine whether to accept or reject the order. If the user has a score below the minimum scorecard threshold level, the user can be blocked and a message can be sent to the user informing the user of the reason for the block. If the user has a score above the minimum scorecard threshold level, the exchange computer system 110 can proceed with subsequent operations such as the ones described below in FIG. 2. If the user was not previously listed in the scorecard, the conditional order engine 136 can create a new entry for the user and assign a neutral score to the user that is above the minimum scorecard threshold level.

The invitation generator 140 is configured to generate an invitation for a user to create a new firm order based on the terms set forth in an existing conditional order, as described in more detail below with respect to FIG. 2. In some implementations, the invitation generator 140 can generate the invitation in response to a signal received from the OMS 134 indicating that two conditional offers are a likely (potential) matched. The invitation generated by the invitation generator 140 can be a message transmitted through network 114 to user devices 116, 118, 120 or market participants 122. The message can be an electronic message or a printed message and can include terms from a conditional order that are to be used to generate a new firm order.

FIG. 2 is a flowchart of an example method 200 for processing conditional orders in an electronic exchange system. The electronic exchange system is configured to execute operations 210-270 and includes one or more servers that are the same as or similar to the computer exchange system 100 described with respect to FIG. 1. Orders may be received from user devices, such as user devices 116, 120, or market participants 122.

In operation 210, an exchange server of the electronic exchange system receives data indicative of a first conditional order from a user device (referred to as first user device). For example, a user associated with the first user device may be willing to take some risk in return for trading larger volumes or improved profits. As such, the user may be interested in placing a conditional order in which the user offers to trade a financial instrument at a different (e.g., larger) quantity or price of the financial instrument than the user is willing to commit to in a firm order. In doing so, the user takes some risk because, by the time another order is matched to the user's conditional order, the user may no longer have the volume offered in the conditional order. However, because the user can benefit from greater size and/or narrower spreads, the user may be willing to take the additional risk.

In some implementations, the first conditional order can be received when a firm order for the same symbol is available at the same or other venues. For instance, a firm order can be placed at a trading venue that only accepts firm orders. At the same time, a conditional order for the same symbol can be received by the exchange server of the electronic exchange system implementing method 200, which is configured to receive and process conditional offers and firm offers. As an example, a user can place a firm order for 30,000 shares of XYZ in a venue only accepting only firm orders, and place a conditional order for 40,000 shares of XYZ at another venue that also accepts conditional orders. In some implementations, the exchange server of the electronic exchange system can receive both the firm order and the conditional order from the first user device.

To place a conditional order, the user can use a trading program on the first user device and provide the terms and conditions at which the user would like to place the order. For example, the user can make selections and provide input regarding the price, quantity, and any other condition (e.g., minimum volume, maximum price, preferred date, and expiration of the order) through a graphical user interface, keyboard, or mouse of the first user device for trading a financial instrument. The trading program on the first user device receives the conditional order information, generates a conditional order based on the received information, and instructs the first user device to transmit the conditional order to the exchange server of the electronic exchange system.

In some implementations of a conditional order, the user can select the option of pair trading in which two conditional orders must be executed simultaneously. A user can specify a ratio as one of the parameters for executing a pair trade. The ratio can be defined flexibly by the user (e.g. one leg—buy 11,000 shares of ABC; and second leg—sell 19,000 shares of XYZ, provided that the absolute net value of the trade is less than $4,000). In the context of options trading, the ratio can be expressed in the form of a delta of the option. For example, if an option delta is 0.6 and the market participant is quoting 100 lots, the pair would be expressed as buy 100 lots of the call option and sell 60 lots of the futures provided that the net proceeds are less than a specified amount (e.g., $4,000). If the pair cannot be traded simultaneously, neither leg of the pair is executed. In some implementations, an option quote can be paired with an underlying instrument (e.g. futures contract), provided both are traded in the same venue.

Conditional orders that include pair trading conditions can create a powerful market making regime in which the sizes and the spreads for the pair are significantly more attractive than is possible with trades according to current market trading practices.

In operation 220, the exchange server of the electronic exchange system can receive data indicative of a second conditional order from another user device (referred to as second user device). A user of the second user device may place the second conditional order in a similar manner as described above with respect to the user of the first user device. The electronic exchange system can receive large (e.g., thousands) numbers of orders each second from various devices of market participants.

In operation 230, the electronic exchange system determines whether the first and second conditional orders potentially match. As explained above, an order matching system can determine that a match exists for an order (for example, when an offered quantity and price of a financial instrument in the first conditional order matches a quantity and price of the financial instrument in the second conditional offer), and can mark the matched order or quote with a broker-specific identifier so that the broker sending the order or quote information can be identified. Here, if the terms and conditions of the first conditional order match the terms and conditions of the second conditional order, the conditional order engine of the exchange server can determine that the two orders are potentially a match.

In implementations involving paired trades, the electronic exchange system advantageously does not lock the order book for a specific symbol in order to accept and process paired trades. By keeping the order book unlocked, greater flexibility in order handling can be achieved and multiple executions around the same symbol(s) can be executed in a tight time frame.

If in operation 230, the electronic exchange system determines that the first and second conditional orders do not match, the electronic exchange system can wait until a potential match with subsequently received conditional orders is detected. If no potential match between available orders is detected for a certain period of time, the method 200 may terminate.

In operation 240, the electronic exchange system generates and transmits an invitation to generate a new firm order. In particular, after the conditional order engine or order matching system determines that a potential match exists between two conditional orders, the electronic exchange system can send a signal or instruction to the invitation generator of the conditional order engine to generate an invitation for each of the users to convert their respective conditional orders to firm orders. For example, a new first firm order can be generated based on the first conditional order, and a new second firm order can be generated based on the second conditional order. The invitation for generating the first firm order is transmitted to the first user device and the invitation for generating the second firm order is transmitted to the second user device. In some implementations, one or more details of the orders or potential trade can be sanitized or anonymized such that the details are omitted from the invitation. For example, details specifying the parties involved in a potential trade, or quantity to be traded can be omitted from the invitation.

The users of the first user device and second user device may have previously existing but unfilled firm orders associated with the same symbol or volume. To reduce the possibility of conflicts, the invitation that is generated can include an indication of one or more of the following: (1) an invitation pending time period, and (2) an instruction to update related firm orders. The invitation pending time period is a time period during which the invitation is pending. After the time period is complete, the invitation expires. During the invitation pending time period, a user (to which the invitation is directed) can verify the volume available for trading, cancel any related firm orders as appropriate at other venues, and “firm up” (replace the conditional order with a new firm order with the actual volume available for trading at the same price terms as the conditional order). The invitation pending time period is of a reasonable length of time that would allow a user to perform these actions.

If the user's previously-existing but unfilled firm order associated with the same symbol or volume is placed with the same electronic exchange system, the conditional order engine in the exchange system can determine whether the financial instrument volume specified by the first conditional order is still available, and if so, cancel the previously-existing firm order. For example, if the unfilled firm order was for 19,000 shares of XYZ and the conditional order was for 20,000 shares of XYZ, the conditional order engine 136 will verify that 20,000 XYZ share are still available, cancel the firm order for 19,000 XYZ shares, and convert the conditional order to a new firm order for 20,000 XYZ shares at the price offered in the conditional order. If no earlier firm order exists, the exchange system can generate a new firm order without sending an invitation.

The generation of firm orders in the above-noted manner can be an option made available to users should the users prefer such expeditious trading functionality to a manual one in which the user is prompted to accept the generation of a new firm order or cancellation of previously existing but unfilled firm orders. This method provides the benefit of reducing network congestion, e.g., by reducing the number of messages that are sent between the exchange server and user devices, increasing the speed at which the trade can be completed, and providing greater convenience to the users because the transaction does not require additional user input other than the received conditional orders.

The electronic exchange system includes one or more purge ports configured to cancel one or more sets of orders. The purge ports can be coupled to the conditional order engine 136. In general, a purge port may refer to a dedicated port that permits a user to simultaneously cancel all or a subset of its orders in one or more symbols across multiple logical ports by requesting the exchange computer system 110 to effect such cancellation. For example, in some implementations, the conditional order engine 136 may generate and send instructions to a purge port to cancel orders that are associated with a symbol or firm order upon a determination by the conditional offer engine 136 or receipt of a message from user device interested in generating a new order from a conditional order.

In operation 250, the electronic exchange system receives a new firm order from the first user device and a new firm order from the second user device. As explained above, the new first firm order corresponds to the terms of the first conditional order and can be received in response to the invitation sent by the exchanger server to the first user device. A new second firm order corresponds to the terms of the second conditional order and can be received in response to the invitation sent by the exchanger server to the second user device. In some implementations as described above, the new firm orders can be automatically generated by the electronic exchange system if the system has received previous authorization to do so from the users.

In operation 260, the electronic exchange system determines that the two firm orders are a match and executes the trade of the new firm orders. For example, the OMS 134 can determine if the quantity of financial instruments and price specified in the second firm order matches the quantity of financial instruments and price specified in the first firm order received from the first user device. When a match exists, a trade based on the firm and second firm orders is executed.

The exchange server can also determine if the user associated with the first user device can still trade the quantity of the financial instruments specified by the second firm order. If the quantity is not available, both firm orders can be canceled and the scorecard of the user associated with the first user device can have a negative score added. If the quantity is available and the trade is completed, the scorecard of the user associated with the first user device can have a positive score added.

In operation 270, the electronic exchange system generates and transmits a report that includes information of the executed trade. The information in the report can include one or more of details regarding the parties or firms involved, the financial instrument being traded, the price and quantity of the trade, the time at which the trade was completed, and details of any earlier firm orders that were canceled in the process of implementing the trade. The report can be transmitted to the first user device, second user device, and/or other exchanges. In some implementations, if the firm orders are canceled, as described above, a report is transmitted to the first user device and second user device. The report can include data indicative of the cancelation of the respective user device's firm order. The report can also include a reason for the cancellation and other details such as a date and time of cancellation.

As described above, upon completion of the trade, the fill information is passed through an OMS and ORS to one or more user devices and to a CTM system. The CTM system matches the buy side and sell side of a trade, and forwards the matched trade to a third party organization that verifies the proper clearance of the trade. The OMS can format the quote and sale update information and send that information through an internal distribution system that refreshes display screens on the floor, in addition to submitting the information to a quote and trade dissemination service such as, in the case of options, the Options Price Reporting Authority (OPRA). In the case of equities, the information would be submitted to the Securities Information Processor (SIP).

The electronic exchange system can transmit the report through any suitable user-selected method, such as e-mail messaging, text messaging, fax messaging, or, in general, other suitable mechanisms for securely transmitting messages. In response to receiving a report, the user device can generate an alarm signal to indicate to the user that a trade report has been received. The alarm signal can be output in the form of a flashing LED light, graphical message displayed on a display of the user device, or audio signal.

In some implementations, method 200 can also be used to execute partial orders. In such implementations, a third conditional order for a financial instrument may also be received at or around the same time the first and second conditional order for the financial instrument are received. The third conditional order may be generated and transmitted from the first user device, the second user device, or a third user device. If the first order is an offer, the conditional order engine can determine that a potential match exists when it determines that the first quantity of the first order is equal to or greater than a sum of the second quantity associated with the third conditional order (e.g., a bid) and a third quantity of the financial instrument associated with the third conditional order (e.g., a bid). In response to this determination, the conditional order engine can send an instruction to the invitation generator to transmit invitations to the respective devices from which the conditional orders were received to generate new firm orders corresponding to the conditional orders, as described above.

In some cases, if firm orders are then received from the user devices that placed the conditional orders, the exchange server can determine that a match exists and execute a three-order trade. In some cases, if a firm order corresponding to one of the second or third conditional order is received and a firm order corresponding to the other one of the second or third conditional order is not received, the exchange server can execute a trade based on the first firm order and the firm order corresponding to one of the second or third conditional order that is received. The first firm order can be updated to generate either a new firm order or a new conditional order based on any quantity of the financial instrument that remains after the trade is executed.

If a firm order is not received from a device to which an invitation to generate a firm order is sent, the conditional order received from that device can, in some cases, be canceled or, in some cases, can remain open to be matched in future. The scorecard for the user from whom a response to an invitation is not received can receive a negative score. The negative score is indicative of the lack of response, and more generally, the poor trading performance of the user.

It will be understood that various modifications can be made. For example, other useful implementations could be achieved if steps of the disclosed techniques were performed in a different order and/or if components in the disclosed systems were combined in a different manner and/or replaced or supplemented by other components. Accordingly, other implementations are within the scope of the disclosure.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together. The term “and/or” is also intended to be construed in this manner.

The use of the terms “first,” “second,” “third,” etc., are not necessarily used herein to connote a specific order or number of elements. Generally, the terms “first,” “second,” “third,” etc., are used to distinguish between different elements as generic identifiers. Absent a showing that the terms “first,” “second,” “third,” etc., connote a specific order, these terms should not be understood to connote a specific order. Furthermore, absent a showing that the terms “first,” “second,” “third,” etc., connote a specific number of elements, these terms should not be understood to connote a specific number of elements.

What is claimed is:

1. A method for conditional trading implemented via an exchange computer system, the method comprising:
receiving, from a first user device connected to the exchange computer system, data indicative of a first conditional order for a financial instrument;
receiving, from a second user device connected to the exchange computer system, data indicative of a second conditional order for the financial instrument;
determining that the first conditional order and the second conditional order potentially match;
responsive to determining that the first conditional order and the second conditional order potentially match, sending a first invitation to the first user device to submit a first firm order for the financial instrument and a second invitation to the second user device to submit a second firm order for the financial instrument;
receiving the first firm order for the financial instrument from the first user device and the second firm order for the financial instrument from the second user device;
executing a trade based on the first firm order and the second firm order; and
sending a first report to the first user device and a second report to the second user device, wherein the first report and the second report each include data indicative of a quantity of the financial instrument traded.

2. The method of claim 1, wherein the exchange computer system is a distributed computer system comprising:
an order entry port;
an order routing system;
an order matching system; and
a conditional order engine.

3. The method of claim 2:
wherein the order entry port is configured to receive the first conditional order;
wherein the order routing system is configured to route the first conditional order according to a destination associated with the first conditional order;
wherein the conditional order engine is configured to determine that the first conditional order and the second conditional order potentially match based on one or more matching rules; and
wherein the order matching system is configured to match the first firm order and the second firm order.

4. The method of claim 1, wherein the first conditional order includes a first quantity of the financial instrument, wherein the second conditional order includes a second quantity of the financial instrument, and wherein the quantity of the financial instrument traded is equal to the second quantity.

5. The method of claim 4, further comprising:
receiving data indicative of a third conditional order for the financial instrument, wherein the first quantity is equal to or greater than a sum of the second quantity and a third quantity of the financial instrument associated with the third conditional order.

6. The method of claim 4, wherein the invitation does not indicate the second quantity.

7. The method of claim 4, wherein the invitation indicates the second quantity.

8. The method of claim 4, further comprising:
responsive to receiving the first firm order for the financial instrument, determining that the first quantity is available to trade.

9. The method of claim 8, wherein the trade based on the first firm order and the second firm order is executed responsive to determining that the first quantity is available to trade.

10. The method of claim 4, further comprising:
responsive to receiving the first firm order for the financial instrument, determining that the second quantity is available to trade.

11. The method of claim 1, further comprising:
generating, based on the executing of the trade, a score indicative of a trading performance of a user of the first user device.

12. A method for conditional trading implemented via an exchange computer system, the method comprising;
receiving, from a first user device connected to the exchange computer system, data indicative of a first conditional order for a financial instrument, the first conditional order including a first quantity of the financial instrument;
receiving, from a second user device connected to the exchange computer system, data indicative of a second conditional order for the financial instrument, the second conditional order including a second quantity of the financial instrument;
determining that the first conditional order and the second conditional order potentially match;
responsive to determining that the first conditional order and the second conditional order potentially match, sending an invitation to the first user device to submit a first firm order for the financial instrument and an invitation to the second user device to submit a second firm order for the financial instrument;
receiving the first firm order for the financial instrument from the first user device and the second firm order for the financial instrument from the second user device;
determining that the first quantity is not available to trade;
canceling the first firm order and the second firm order; and
sending a report to the first user device including data indicative of the cancelation of the first firm order and a report to the second user device including data indicative of the cancelation of the second firm order.

13. The method of claim 12, further comprising:
generating, based on the determining that the first quantity is not available to trade, a score indicative of a trading performance of a user of the first user device.

14. The method of claim 13, further comprising:
determining that the score indicative of the trading performance of the user of the first user device is less than a threshold value; and
blocking the user of the first user device from participating in conditional trading.

15. A method for conditional trading implemented via an exchange computer system, the method comprising;
receiving, from a first user device connected to the exchange computer system, data indicative of a first conditional order for a financial instrument, the first conditional order including a first quantity of the financial instrument;
receiving, from a second user device connected to the exchange computer system, data indicative of a second conditional order for the financial instrument, the second conditional order including a second quantity of the financial instrument;
determining that the first conditional order and the second conditional order potentially match;
responsive to determining that the first conditional order and the second conditional order potentially match, sending an invitation to the first user device to submit a firm order for the financial instrument;
determining that the first user device did not respond to the invitation; and
canceling the first conditional order.

16. The method of claim 15, further comprising:
generating, based on the determining that the first user device did not respond to the invitation, a score indicative of a trading performance of a user of the first user device.

17. The method of claim 15, further comprising:
receiving, from a third user device connected to the exchange computer system, data indicative of a third conditional order for the financial instrument;
determining that the second conditional order and the third conditional order potentially match;
responsive to determining that the second conditional order and the third conditional order potentially match, sending an invitation to the second user device to submit a second firm order for the financial instrument;
receiving, from the second user device, a second firm order for the financial instrument;
executing a trade based on the second firm order and the third conditional order; and
sending a report to the second user device, wherein the report includes data indicative of a quantity of the financial instrument traded.

18. The method of claim 15, wherein the exchange computer system is a distributed computer system comprising:
an order entry port;
an order routing system;
an order matching system;
a conditional order engine; and
a purge port.

19. The method of claim 18:
wherein the order entry port is configured to receive the first conditional order;
wherein the order routing system is configured to route the first conditional order according to a destination associated with the first conditional order;
wherein the conditional order engine is configured to determine that the first conditional order and the second conditional order potentially match based on one or more matching rules; and
wherein the purge port is configured to cancel the first conditional order.

20. An exchange computer system comprising:
an order entry port configured to receive from a first user device connected to the exchange computer system, data indicative of a first conditional order for a financial instrument, and to receive from a second user device connected to the exchange computer system, data indicative of a second conditional order for the financial instrument;
an order routing system configured to route the first conditional order according to a destination associated with the first conditional order, and to route the second conditional order according to a destination associated with the second conditional order;
a conditional order engine configured to determine that the first conditional order and the second conditional order potentially match and, responsive to determining that the first conditional order and the second conditional order potentially match, to send a first invitation to the first user device to submit a first firm order for the financial instrument and to send a second invitation to the second user device to submit a second firm order for the financial instrument; and
an order matching system configured to:
match the first firm order from the first user device and the second firm order for the financial instrument from the second user device based on one or more trading rules; and
execute a trade based on the first firm order and the second firm order.

21. The exchange computer system of claim 20:
wherein the order entry port is further configured to receive the first firm order for the financial instrument from the first user device and the second firm order for the financial instrument from the second user device; and
wherein the conditional order engine is further configured to, responsive to execution of the trade based on the first firm order and the second firm order, send a first report to the first user device and a second report to the second user device, wherein the first report and the second report each include data indicative of a quantity of the financial instrument traded.
